(19) United States
(12) Patent Application Publication
(10) Pub. No.: US 2012/0319393 A1
(43) Pub. Date: Dec. 20, 2012

(54) FORM WITH INTEGRATED FOLDING CARD, LAMINATE FOR PRODUCING THE FORM AND METHOD FOR PRODUCING A FOLDING CARD

(76) Inventor: Jules Fischer, Oberwil-Lieli (CH)

(21) Appl. No.: 12/998,255

(22) PCT Filed: Dec. 21, 2010
(86) PCT No.: PCT/CH10/00323

§ 371 Date: Sep. 10, 2012

(30) Foreign Application Priority Data
Jan. 14, 2010 (CH) 43/10

(51) Int. Cl. B42D 15/00; B32B 38/10; B32B 5/00; B32B 38/00

(52) U.S. Cl. 283/62; 156/227; 428/58

(57) ABSTRACT

A form with an integrated folding card produced using two core parts which can be removed from the form and two covering parts which can be removed from the form. The two core parts have a flat substrate and a first adhesive layer. The two covering parts have an at least partially transparent top layer and a second adhesive layer. The form has a first punch which forms the two core parts. The form has a second punch which forms the two covering parts. The core parts and the covering parts are coextensive. The form has a first and a second page. The first page, as viewed from the front, comprises the flat substrate, the first adhesive layer, a first dividing layer and a first carrier layer and contains the two core parts formed by the first punch. The first punch is made from the front as far as the first carrier layer at the most. The second page, as viewed from the front, comprises the top layer, the second adhesive layer, a second dividing layer and a second carrier layer and contains the two covering parts formed by the second punch. The second punch is made from the front as far as the second carrier layer at the most. A laminate for producing the form and a method for producing a personalised folding card which is plasticised on both sides is also provided.

### CROSS-REFERENCE TO RELATED APPLICATIONS

This application is a National Stage application of International Application No. PCT/CH2010/000323, filed on Dec. 21, 2010, which claims priority of Swiss patent application number 43/10, filed on Jan. 14, 2010, both of which are incorporated herein by reference in their entireties.

### BACKGROUND OF THE INVENTION

1. Field of the Invention

The present invention relates to a form with an integrated folding card, wherein the folding card can be produced using two core parts which can be removed from the form and two covering parts which can be removed from the form, wherein the two core parts have a flat substrate and a first adhesive layer, wherein the two covering parts have an at least partially transparent top layer and a second adhesive layer, wherein the form has a first punch which forms the two core parts, wherein the form has a second punch which forms the two covering parts, and wherein the core parts and the covering parts are coextensive.

The invention also relates to a laminate for producing a form with an integrated folding card and a method for producing a personalised folding card which is plasticised on both sides, consisting of two core parts and two covering parts, using a form in which the two core parts and the two covering parts are each integrated in a removable manner along a fold line.

2. Description of the Prior Art

WO 2004/018222 describes a form with a detachable, integrated folding card consisting of two connected parts, wherein the form consisting of a multi-layer material comprises a first paper layer, a first adhesive layer, a foil layer, a second adhesive layer, a dividing layer and a second paper layer. A punch from the side of the first paper layer as far as the dividing layer produces the two connected parts of the folding card. When detaching the parts of the folding card from the form, the layers are separated between the second adhesive layer and the dividing layer. The two parts are folded together to form the finished folding card. Such a folding card can be personalised by printing the form on both sides. The personalisation is however unprotected on the surface of the folding card and is therefore not very long-lasting. Also, the whole form consists of multi-layer material, which has a negative effect on the material costs.

Like WO 2004/018222 above, WO 2008/128362 describes a form similar in structure with an integrated folding card, in this case only a limited region of the form having a multi-layer material. The multi-layer material is applied to one or both sides of the form paper. The folding card can likewise be personalised on both sides, the personalisation also being situated in an unprotected manner on the surface of the folding card.

WO 2007/115420 describes a form with an integrated folding card, it being possible to personalise and then plasticise the folding card on both sides. In this case a multi-layer material consisting of a first adhesive layer, a first dividing layer, a carrier layer, a second dividing layer, a second adhesive layer and a foil layer is applied to the rear of the form paper. Two individual, unconnected core parts are punched out by means of a first punch from the front through the carrier layer as far as the second dividing layer. These two core parts are situated inside the finished folding card. A second punch from the rear through the foil layer as far as the second dividing layer produces two connected covering parts, which are situated on the outside in the finished folding card, these covering parts being larger in area than the core parts. The personalisation on the finished folding card is thus protected by plasticisation, but a transparent border running around the core parts is produced, which is not aesthetically appealing. The form has the further disadvantage that it is complicated to use. After personalisation, the two covering parts are detached individually from the form, rotated and inserted back into the form with the personalisation facing down. The core parts together with the covering parts are then pressed to the rear out of the form, the carrier layer and the two dividing layers are pulled off the core parts, and the card is folded up. It can easily happen, in particular when detaching, rotating and reinserting the core parts, that the core parts are inserted the wrong way round and the personalisation is thus not the right way round on the two sides of the folding card.

WO 2008/043193 describes a form with an integrated folding card. The folding card can be personalised on both sides, the personalisation being protected by plasticisation in the finished folding card. The form consists of a flat substrate which is provided with two different multi-layer materials in two non-overlapping regions. The two regions each have a stamp which is made from the front, as a result of which two connected core parts are punched out in one region and two connected covering parts are punched out in the other region. The core parts and the covering parts are coextensive, a transparent border running round the core parts being avoided. The form also has a fold line in the region between the two multi-layer materials, which fold line is produced by a perforation punch. The finished folding card can then be produced by repeated removal of different layers and repeated folding to and fro. The foam however has the disadvantage that during its production the punches must be made exactly in register and with the same punching plate so that the individual parts match each other exactly when folded up when the form is used. The production of the form is thus complex. The form is also rather complicated to handle.

The forms described in WO 2007/115420 and WO 2008/043193 could in particular not become established, which is presumably connected with their production complexity, material costs and/or their lack of completely simple handling by the end user when removing and creating the folding card.

### SUMMARY OF THE PRESENT INVENTION

The object of the invention is to specify a form with an integrated folding card of the type mentioned in the introduction, which is simple and inexpensive to produce and simple to handle. It should be possible to personalise the folding card over its entire area on both sides. The finished folding card should furthermore be plasticised over its entire area on both sides and be aesthetically appealing. A method should also be specified which is easy to carry out and in which a finished folding card can be produced using a form with in each case two integrated, removable core and covering parts.

This is achieved according to the invention in a form with an integrated folding card by the features of claim 1. The form according to the invention is correspondingly characterised in that the form comprises a first and a second page. The first page comprises, as viewed from the front, at least in a part-region, the flat substrate, the first adhesive layer, a first dividing layer and a first carrier layer and contains the two core parts formed by the first punch, wherein the first punch is made from the front as far as the first carrier layer at the most. The second page comprises, as viewed from the front, at least in a part-region, the top layer, the second adhesive layer, a second dividing layer and a second carrier layer and contains the two covering parts formed by the second punch, wherein the second punch is made from the front as far as the second carrier layer at the most.

The form according to the invention allows the production of folding cards which are personalised and plasticised over their entire area on both sides. Handling is greatly simplified compared to the form of WO 2007/115420. The finished folding card is also aesthetically more appealing because the adhesion of coextensive core and covering parts avoids the transparent border typical of WO 2007/115420.

Compared to the form of WO 2008/043193, which needs two rear applications of multi-layer materials and complex punching from the front for its production, the production processes of the form according to the invention are greatly simplified. The punches for the core parts and the punches for the covering parts do not have to be in register. The form is also simpler to handle.

The subject matter of the invention is also formed by a laminate for producing a form consisting of two pages connected to each other, with an integrated folding card. The laminate comprises a first web and a second web. The first web comprises, as viewed from the front, the flat substrate, the first adhesive layer, the first dividing layer and the first carrier layer. The second web comprises, as viewed from the front, the top layer, the second adhesive layer, the second dividing layer and the second carrier layer. The first and second webs are connected to each other by a connection along a side edge. Such a laminate can be produced in the form of rolls. When a form with an integrated card is produced, the core parts of the first page can be punched out in the first web and the covering parts of the second page can be punched out in the second web. In the same pass, the core parts can be personalised and the webs can be cut to form forms of the desired size.

The connection of the first and second webs can be produced by the first dividing layer and the first carrier layer of the first web simultaneously being the second dividing layer and the second carrier layer of the second web. The top layer of the second web and the flat substrate of the fist web can also be formed by a continuous printable foil layer, and the continuous printable foil layer can have an opaque coating in the region of the flat substrate or of the first web. Instead of or in addition to the opaque coating, the first adhesive layer can be an opaque adhesive layer.

In contrast to this, the connection of the first and second webs can also be produced by the first dividing layer and the first carrier layer of the first web partially overlapping the second web and thereby partially forming the second dividing layer and the second carrier layer of the second web, or by the second dividing layer and the second carrier layer of the second web partially overlapping the first web and thereby partially forming the first dividing layer and the first carrier layer of the first web.

The subject matter of the invention is also formed by a method for producing a folding card using a form in which two core parts and two covering parts are each integrated such that they can be removed and are connected along a fold line. The finished folding card consists of two core parts and two covering parts. The two core parts comprising a substrate and a first adhesive layer are adhesively bonded to each other in a coextensive manner with the first adhesive layer, and at least one of the two outwardly facing surfaces of the substrate is personalised. The two covering parts comprising a top layer and a second adhesive layer are adhesively bonded to the outwardly facing surfaces of the two core parts in a coextensive manner with the second adhesive layer. The finished folding card can have a personalisation on both sides and is plasticised on both sides by the covering parts. If required, a subsequent personalisation is possible by providing the top layer with a writeable layer. Conversely, the top layer can be provided with a silicone layer which prevents subsequent writing on the top layer.

The method for production is characterised by the following steps:
a) Personalisation of at least one surface of the substrate of the two core parts in the form containing the core parts. Such a personalisation can for example be carried out with a laser or ink jet printer.
b) Removal of the two core parts from the form containing the core parts and folding up the two core parts along the fold line and adhesively bonding the two core parts to each other by means of the first adhesive layers.
c) Detachment of a first covering part of the two covering parts from the form containing the covering parts in such a manner that the second covering part connected to the first covering part remains at least partially connected to the form. This produces a depression in the form as a fitting aid which makes it easier to correctly align the core parts which are adhesively bonded to each other.
d) Insertion of the core parts which are adhesively bonded to each other into the depression produced by the detachment of the first covering part.
e) Adhesively bonding the first, detached covering part onto the upper of the two core parts in the depression in order to plasticise the outer surface of the core part.
f) Removal of the core parts plasticised by the first covering part on one side in this manner from the depression together with the second covering part from the form containing the two covering parts.
g) Adhesively bonding the second covering part onto the previously lower of the two core parts in the depression by folding up the two covering parts along their fold lines in order to plasticise the outer surface of the core part.

This method for producing a folding card can be carried out using the above-described form, steps a) and b) being carried out on the front of the first page and steps d) to g) being carried out on the front of the second page.

Using a form in which the first and second pages are connected, the method for producing a folding card can be carried out using the following steps:
a) Personalisation of at least one surface of the substrate of the two core parts in the form containing the core parts,
b) Removal of the two covering parts from the form containing the covering parts,
c) Insertion of the two covering parts into the depression produced by the removal of the two covering parts in such a manner that the second adhesive layer is exposed,
d) Folding up of the form along a fold line in the form between the core parts and the covering parts in such a manner that the personalised surface of the two core parts is adhesively bonded in a coextensive manner with the two covering parts, in order to plasticise the two core parts,
e) Folding back of the form along the fold line in such a manner that the two covering parts are removed from the depression,
f) Removal of the core parts plasticised in this manner by the two covering parts from the form containing the two core parts, and
g) Folding together of the two core parts together with the two covering parts along the fold line and adhesively bonding the two core parts to each other by means of the first adhesive layers.

The folding of the form along the fold line between the core and covering parts can be made easier by a perforation punch or a stamp.

Advantageous and therefore preferred configurations and developments of the invention are outlined in the dependent claims.

### BRIEF DESCRIPTION OF THE DRAWINGS

The invention is explained in more detail below using exemplary embodiments in connection with the drawing. In the figures:

FIG. 1 shows a form with an integrated folding card according to the invention under a) in a plan view of a portion of the front of a first page, under b) in a section (I-I) of the first page, under c) in a plan view of a portion of the front of a second page, and under d) in a section (II-II) of the second page;

FIG. 2 shows a method for producing a folding card using the form of FIG. 1 in section (I-I) under a)-g) in different phases;

FIG. 3 shows a form with an integrated folding card in section with connected first and second pages under a)-e) variants of the connection; and

FIG. 4 shows a method for producing a folding card using a form with connected pages under a)-d) in different phases.

### DETAILED DESCRIPTION OF THE PRESENT INVENTION

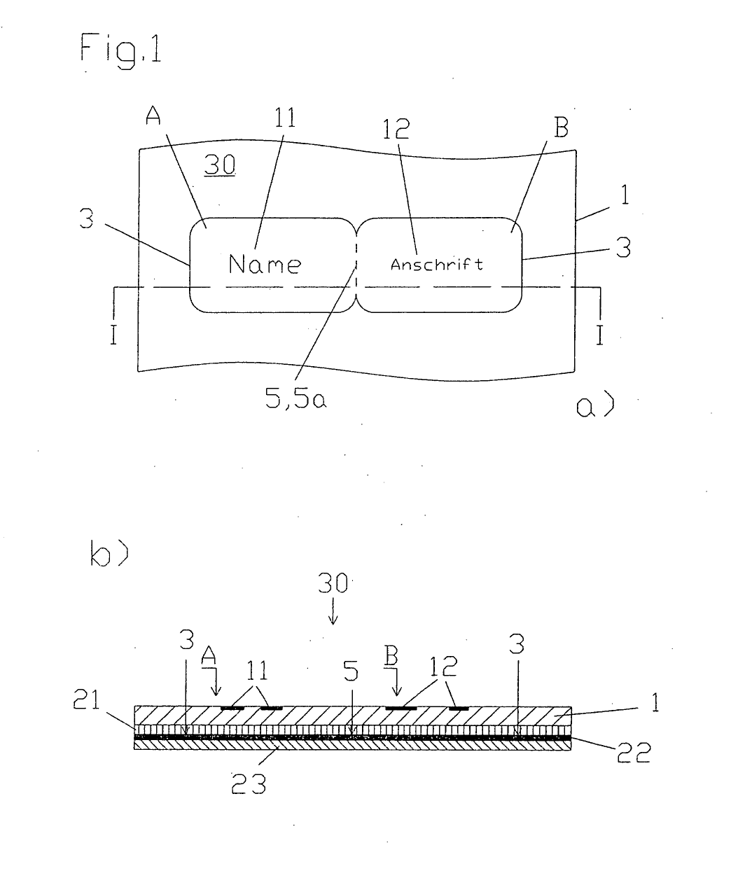

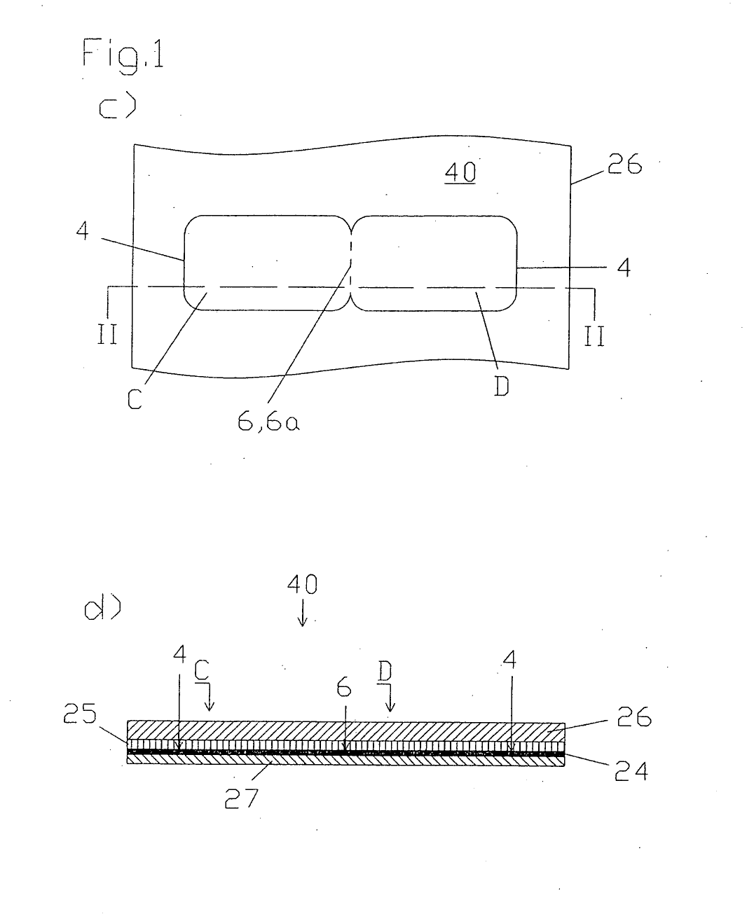

FIG. 1a) shows a portion of a first page 30 of a form with an integrated folding card in a plan view of the front, where 1 denotes a flat substrate. The material of the substrate 1 can be a paper layer with a thickness of 70 to 250 μm, preferably 100 to 160 μm. Two core parts A, B, which are arranged adjacently to each other in the same plane, are punched out by a first punch 3 made in the front of the form. The two core parts A, B are coextensive and are connected along a fold line 5a. A first perforation punch 5 along the fold line 5a makes it easier to fold up the two core parts A, B when producing the finished folding card. The surfaces of the two core parts A, B left free on the front of the form can be printed for example with a laser or ink jet printer, which is indicated by the personalisation 11, 12. Such a personalisation can be for example name and address. Other personalisations such as writing such as a signature, an attached photo or the like are also possible. The material of the substrate can also be a printable foil layer, which is preferably opaque or is coated with an opaque layer on the front or back.

The form could also be provided with a transponder, which can be for example an RFID label which can be detected contactlessly. Such a transponder can be adhesively bonded onto the front of the flat substrate 1 in the region of the core parts A, B or adhesively bonded between the flat substrate and a first adhesive layer 21, in the second case the transponder coming to lie between the core parts A, B in the finished folding card and thus not being visible from the outside as long as the core parts are opaque.

FIG. 1b) shows the first page 30 of the form in section along section line I-I in FIG. 1a). As already mentioned, the flat substrate 1 can be printed on the front in the regions of the core parts A, B, which is shown by the personalisations 11, 12. The first page 30 comprises, in the following order as viewed from the substrate 1: the flat substrate 1, the first adhesive layer 21, a first dividing layer 22 and a first carrier layer 23. When a transparent foil layer is used as the flat substrate 1, the first adhesive layer 21 can be opaque instead of the opaque coating.

The two core parts A, B are punched out by the first punch 3 which is made from the front in such a manner that they are connected along the fold line 5a as shown in FIG. 1a). The first punch 3 goes through the flat substrate 1 as far as into the first adhesive layer 21 or dividing layer 22 and no further than the carrier layer 23, so that the carrier layer 23 is not penetrated. The carrier layer can however be slightly stamped. The first perforation punch 5 extends, like the first punch 3, as far as the carrier layer 23. The core parts A, B can be removed from the form by detaching their first adhesive layer 21 from the first dividing layer 22.

FIG. 1c) shows a portion of the form in a plan view of the front of a second page 40, where 26 denotes an at least partially transparent top layer. The material of the top layer can be a foil layer, preferably a highly transparent polyester foil with a thickness between 23 and 200 μm, preferably 100 μm. The top layer 26 could be provided with a hologram. The top layer can also be provided with a writeable layer so that the finished folding card can be personalised again later, for example with a signature of the user. Conversely, the top layer can also have a silicone layer in order to prevent subsequent personalisation of the finished folding card.

Two covering parts C, D, which are arranged adjacently to each other in the same plane, are punched out by a second punch 4 made in the front of the second page 40. The two covering parts C, D are coextensive and are connected along a fold line 6a. A second perforation punch 6 along the fold line 6a makes it easier to fold up the two covering parts C, D when producing the finished folding card.

FIG. 1d) shows the second page 40 of the form in section along section line in FIG. 1c). The second page 40 comprises, in the following order as viewed from the front: a top layer 26, a second adhesive layer 25, a second dividing layer 24 and a second carrier layer 27.

The two covering parts C, D, which are situated on the front of the second page 40, are punched out by the second punch 4 made from the front in such a manner that the two covering parts C, D are connected along the fold line 6a, as shown in FIG. 1c). The second punch 4 goes through the top layer 26 as far as into the second adhesive layer 25 or dividing layer 24 and no further than the carrier layer 27, so that the carrier layer 27 is not penetrated. The second perforation punch 6 extends, like the second punch 4, as far as the carrier layer 27. The core parts C, D can be removed from the form by detaching their second adhesive layer 25 from the second dividing layer 24.

The first and second adhesive layers 21, 25 of the form are preferably a pressure-sensitive adhesive, for example an aqueous polyacrylate or a hot melt adhesive.

The first and second dividing layers 22, 24 are for example silicone coatings which are applied to the first and second carrier layers 23, 27. The first and second carrier layers 23, 27 are a foil layer or a paper layer with a thickness of 23 to 60 μm. With a foil layer as the carrier layer 23, 27, this is preferably 23 to 36 μm thick. With a paper layer as the carrier layer 23, 27, this is preferably 50 to 60 μm thick.

The first and second punches 3, 4 are made all the way round without leaving punching webs. Instead of the perforation punches 5, 6, continuous stamps which extend only partially into the substrate 1 or into the top layer 26 can be present.

A transparent varnish layer can also be present between the top layer 26 and the second adhesive layer 25, which varnish layer has lower cohesion than the adhesion to the top layer 26 and to the second adhesive layer 25. A structured, transparent separating coating, for example in the form of a VOID label, is arranged between the transparent varnish layer and the top layer 26 or the second adhesive layer 25, which separating coating has lower adhesion to the transparent varnish layer than the cohesion in the transparent varnish layer. This additional varnish layer and the separating coating act as a security feature in the finished folding card to prevent changes to the personalisation, as detachment of the top layer results in a cohesion breakage of the transparent varnish layer, specifically in the regions where no separating coating is present. The cohesion breakage can be seen as a visible matting in the varnish layer. The regions which have the separating coating remain transparent.

The first and second pages 30, 40 can for example have an A5 or A4 format.

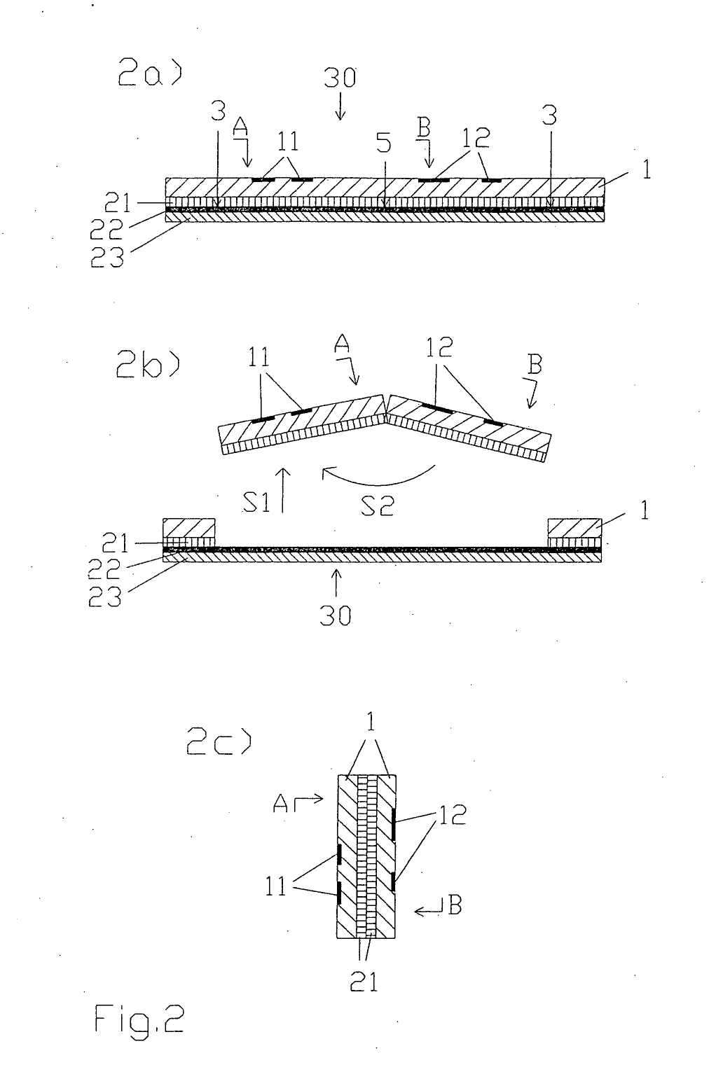

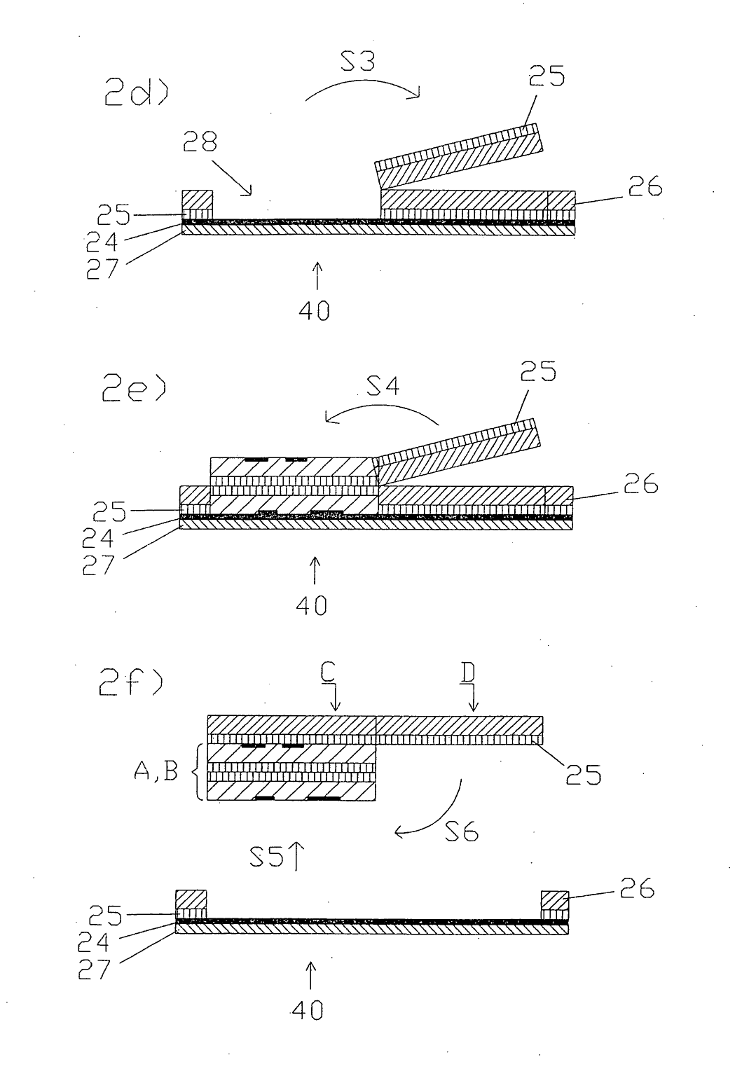

FIG. 2a) to g) show different phases in the production of a folding card using the form of FIG. 1. The figures each show a section along the section lines I-I or II-II of FIG. 1.

FIG. 2a) shows the first page 30 of the form of FIG. 1 in section I-I. The substrate 1 is provided with the personalisation 11 in the region of the core part A and with the personalisation 12 in the region of the core part B.

In FIG. 2b), the two core parts A, B have been removed from the first page 30 of the form S1, the adhesive layer 21 being detached from the dividing layer 22, which remains in the form. The two core parts A, B comprise a part of the flat substrate 1 with the personalisations 11, 12 and a part of the adhesive layer 21. The two core parts A, B are then folded up along the fold line with the perforation punch 5 S2.

FIG. 2c) shows the folded core parts A, B. The two core parts A, B are adhesively bonded to each other in a coextensive manner with the first adhesive layer 21. The personalisations 11, 12 are situated on the outwardly facing surfaces.

FIG. 2d) shows the second page 40 of the form in a section II-II after detaching the first covering part C from the form containing the covering parts C, D. The covering parts C, D are folded along the fold line with the perforation punch 6 S3, the second covering part D remaining at least partially connected to the form. When the first covering part C is detached, the second adhesive layer 25 is separated from the dividing layer 24. The detachment of the first covering part C produces a depression 28 on the front of the second page 40 of the form which is not sticky and in which the previously folded core parts A, B can be inserted, as shown in FIG. 2e). The core parts A, B fit exactly into the depression, because they are coextensive with the covering parts C, D.

After the previously folded up core parts A, B have been placed into the depression 28 in the form, the first covering part C is folded up again and adhesively bonded to the personalised surface of the upper core part in the depression 28 in a coextensive manner with the second adhesive layer 25 S4.

The core parts A, B which are plasticised on one side in this manner by the transparent foil layer of the first covering part C are removed from the second page 40 of the form together with the covering parts C, D S5, as shown in FIG. 2f). The two covering parts C, D are then folded up along the fold line with the perforation punch 6 S6. The second covering part D is adhesively bonded in a coextensive manner to the personalised surface of the previously lower core part in the depression with the second adhesive layer 25 in order to obtain the finished folding card.

The finished folding card, as shown in FIG. 2g), is provided on both sides with the personalisations 11, 12, which are situated on the outwardly facing surfaces of the two core parts A, B. The outwardly facing surfaces of the core parts A, B are plasticised by the top layer 26 of the covering parts C, D.

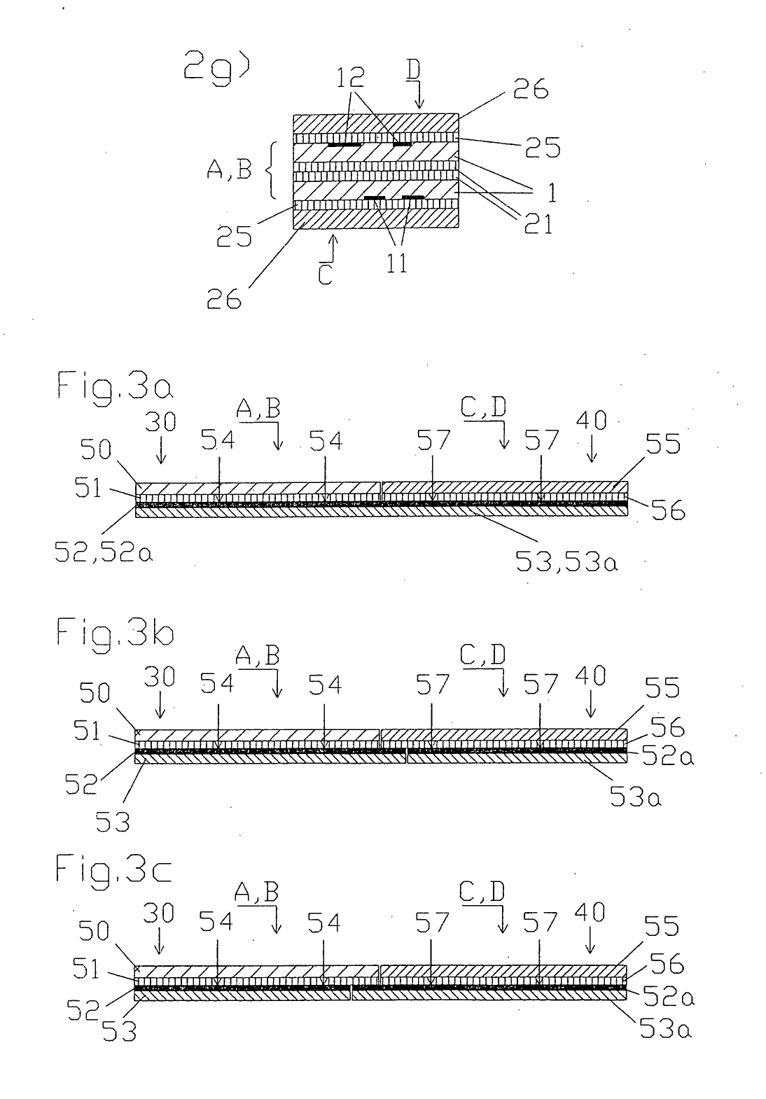

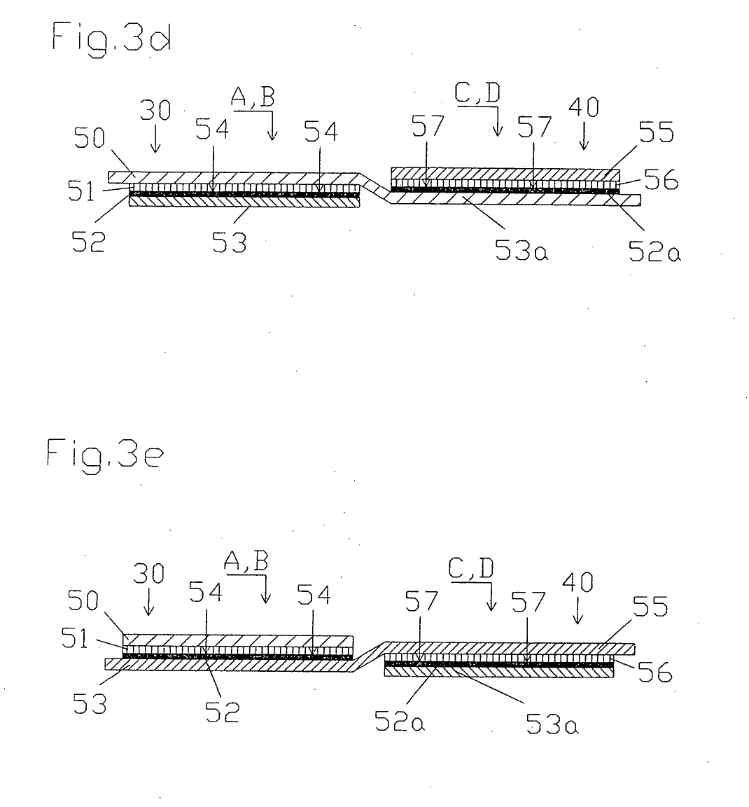

FIGS. 3a) to 3e) each show a form with an integrated folding card in section, the section running orthogonally to the section line I-I or II-II of FIG. 1. FIG. 3a) to e) show a form with an integrated folding card consisting of a first and a second page 30, 40. The first page 30 comprises, at least in a part-region, a flat substrate 50, a first adhesive layer 51, a first dividing layer 52 and a first carrier layer 53. The two core parts A, B are punched out by a first punch 54 made from the front. The second page 40 comprises, at least in a part-region, a top layer 55, a second adhesive layer 56, a second dividing layer 52a and a second carrier layer 53a. The two covering parts C, D are punched out by a second punch 57 made from the front. In contrast to the form of FIG. 1, the two pages 30, 40 are connected to each other along a side edge.

In the form of FIG. 3a), the two pages 30, 40 are connected to each other by means of a common carrier layer 53, 53a. Such a form can be produced inexpensively by first producing a laminate according to the invention without the punches. In a web consisting of silicone paper, comprising the carrier layer 53, 53a and the dividing layer 52, 52a, the silicone layer is coated with the adhesive layers 51, 56. The adhesive layers 51, 56 are preferably a hot melt. The flat substrate 50 and the top layer 55 are then applied parallel to each other in two strips. In order to prevent adhesive from escaping at their edge regions when the flat substrate 50 and the top layer 55 are applied, a region can be adhesive-free in each case in the region between the two adhesive layers 51, 56 and along the edges of the silicone paper. Instead of the web consisting of silicone paper, a web with the material for the carrier layer can also be used as the starting material, which is then siliconised on the production apparatus. The laminate can then be rolled up as an endless web for subsequent further processing or the punches 54, 57 can be applied in the same pass. The substrate and the top layer preferably have the same thickness.

In the form of FIG. 3a), the top layer 55 of the second page 40 and the flat substrate 50 of the first page 30 can be formed by a continuous printable foil layer. This continuous printable foil layer can have an opaque coating in the region of the flat substrate 50 or of the first page 30, which coating is applied to the front or back of the foil layer. Instead of or in addition to the opaque coating, the first adhesive layer 51 can also be opaque.

In the form of FIG. 3b), the two pages 30, 40 are connected by the first dividing layer 52 and the first carrier layer 53 of the first page 30 partially overlapping the second page 40 and thereby partially replacing the dividing layer 52a and the carrier layer 53a of the second page 40.

In the form of FIG. 3c), the two pages 30, 40 are connected by the dividing layer 52a and the carrier layer 53a of the second page 40 partially overlapping the first page 30 and thereby partially replacing the dividing layer 52 and the carrier layer 53 of the first page 40.

In contrast to the production of the form of FIG. 3a), it is possible to proceed from two webs with multi-layer material in the forms of FIGS. 3b) and 3c). The first web comprises the flat substrate 50, the adhesive layer 51, the dividing layer 52 and the carrier layer 53 of the first page 30 and the second web comprises the top layer 55, the adhesive layer 56, the dividing layer 52a and the carrier layer 53a of the second page 40. With regard to the overlapping connection of the two webs, reference is made to the application WO2009/135332, in which two webs are likewise each decreased in thickness along an edge strip by removing at least one layer and connected to each other along this edge strip. In order to achieve even better adhesion of the two pages 30, 40 to each other, the effect of the dividing layer can be reduced or destroyed in the overlapping region by abrasion or other methods, for example corona discharge.

In the form of FIG. 3d) the two pages 30, 40 are connected by the flat substrate 50 of the first page 30 simultaneously being the second carrier layer 53a of the second page 40. The form can for example be produced, with a flat substrate 50, by applying the first adhesive layer 51, the first dividing layer 52 and the first carrier layer 53 to the rear and the top layer 55, the second adhesive layer 56 and the second dividing layer 52a to the front in such a manner that the applied materials do not overlap. The punches 54, 57 are then made at the front.

In the form of FIG. 3e) the two pages 30, 40 are connected by the top layer 55 of the second page 40 simultaneously being the first carrier layer 53 of the first page 30. The form can for example be produced, with a top layer 55, by applying the second adhesive layer 56, the second dividing layer 52a and the second carrier layer 53a to the rear and the flat substrate 50, the first adhesive layer 51 and the first dividing layer 52 to the front in such a manner that the applied materials do not overlap. The punches 54, 57 are then made at the front.

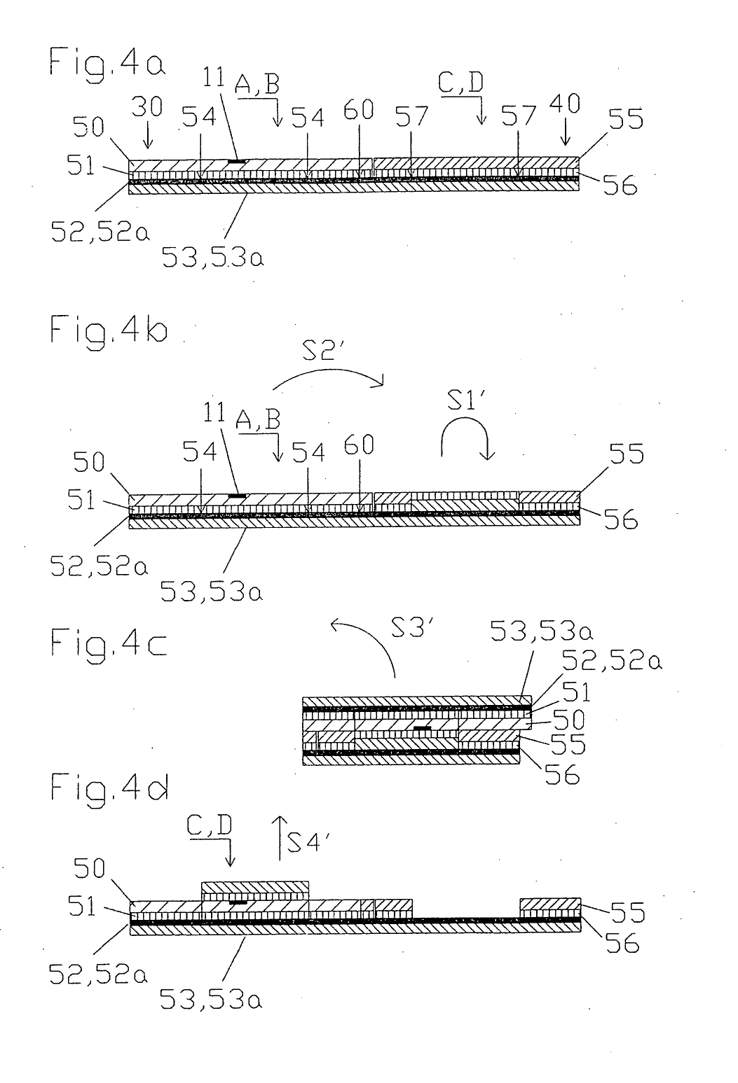

FIG. 4 shows a method for producing a folding card using a form with connected pages under a)-d) in different phases. The form differs from the form in FIG. 3a) in that a fold line 60 is created parallel to the connection line between the two pages 30, 40 by means of a perforation punch or stamp. The fold line 60 lies centrally between the first and second punches 54, 57. The first and second punches 54, 57 are thus also slightly offset with respect to the connection line between the two pages 30, 40.

In FIG. 4a) at least one of the surfaces of the substrate 50 of the two core parts A, B in the first page 30 containing the core parts A, B of the form is provided with the personalisation 11.

FIG. 4b) shows the form with covering parts C, D inserted the other way round. To this end the two covering parts C, D have been removed from the second page 40 containing the covering parts C, D of the form and inserted into the depression produced by the removal of the two covering parts C, D in such a manner that the second adhesive layer 56 of the covering parts C, D is exposed (S1′). The form is then folded up along the fold line 60 which is situated centrally between the core parts A, B and the covering parts C, D (S2′) in such a manner that the surface personalised by the personalisation 11 of the two core parts A, B is adhesively bonded coextensively with the two covering parts C, D by means of the second adhesive layer 56 in order to plasticise the two core parts A, B, as shown in FIG. 4c).

Starting from the state in FIG. 4c), the form is folded back along the fold line 60 (S3′) in such a manner that the two covering parts C, D are removed from the depression. The two covering parts C, D are now situated above the two core parts A, B in the first page 30 of the form, as shown in FIG. 4d).

The core parts A, B plasticised in this manner by the two covering parts C, D are then removed from the page 30 of the form containing the two core parts A, B (S4′) and folded up together with the two covering parts along the fold line between the core part A and the core part B, the two core parts A, B being adhesively bonded by means of the first adhesive layers 51 to form the finished folding card.

This method for producing a folding card can also be carried out with the forms of FIGS. 3a) to 3c). The fold line centrally between the core and covering parts is in this case the connection line between the first and second pages 30, 40 of the form.

It should be noted that the dimensions in the different figures, in particular the thicknesses of the different layers, are not to scale and only serve for illustration.

What has been described above are preferred aspects of the present invention. It is of course not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, combinations, modifications, and variations that fall within the spirit and scope of the appended claims.

I claim:

1. A form with an integrated folding card, wherein the folding card comprise two removable core parts, said removable core parts being removable from the form and two removable covering parts, said removable covering parts being removable from the form,
wherein the two core parts comprise a flat substrate and a first adhesive layer,
wherein the two covering parts comprise an at least partially transparent top layer and a second adhesive layer,
wherein the form has a first punch for forming the two core parts, and a second punch for forming the two covering parts,
and wherein the core parts and the covering parts are coextensive, wherein:
the form comprises a first and a second page, each of the first page and the second page having a front,
wherein the first page comprises, as viewed from the front, at least in a part-region, the flat substrate, the first adhesive layer, a first dividing layer and a first carrier layer, and contains the two core parts formed by the first punch, wherein the first punch is made from the front no greater than the first carrier layer to prevent penetration of the first carrier layer, and
wherein the second page comprises, as viewed from the front, at least in a part-region, the top layer, the second adhesive layer, a second dividing layer and a second carrier layer, and contains the two covering parts formed by the second punch, wherein the second punch is made from the front no greater than the second carrier layer to prevent penetration of the second carrier layer.

2. The form according to claim 1, further comprising a side edge, and wherein the first and the second page are connected to each other along said side edge.

3. The form according to claim 2, wherein said flat substrate affects the connection of the first and second by extending over the first page and being simultaneously the second carrier layer of the second page, or by the top layer extending over the second page and simultaneously being the first carrier layer of the first page.

4. The form according to claim 2, wherein the connection of the first and second pages is achieved by the first dividing layer and the first carrier layer of the first page simultaneously being the second dividing layer and the second carrier layer of the second page.

5. The form according to claim 2, wherein the connection of the first and second pages is achieved by the first dividing layer and the first carrier layer of the first page partially overlapping the second page and thereby partially forming the second dividing layer and the second carrier layer of the second page, or by the second dividing layer and the second carrier layer of the second page partially overlapping the first page and thereby partially forming the first dividing layer and the first carrier layer of the first page.

6. The form according to claim 4, wherein a continuous printable foil layer forms the top layer of the second page and the flat substrate of the first page, and wherein the continuous printable foil layer has an opaque coating in the region of the flat substrate and/or the first adhesive layer is an opaque adhesive layer.

7. The form according to claim 1, wherein the two core parts are arranged in a connected manner adjacently to each other in the same plane in the first page and/or the two covering parts are arranged in a connected manner adjacently to each other in the same plane in the second page.

8. The form according to claim 1, wherein a first perforation punch or first stamp made along a fold line is provided for folding up the connected core parts in an easier manner than with just the fold line, and/or a second perforation punch or second stamp made along a fold line is provided for folding up the connected covering parts in an easier manner than with just the fold line.

9. The form according to claim 1, wherein the first adhesive layer is detachable from the first dividing layer to remove the core parts comprising a part of the substrate and a part of the first adhesive layer from the form and/or the second adhesive layer is detachable from the second diving layer to remove the covering parts comprising a part of the top layer and a part of the second adhesive layer from the form.

10. A laminate for producing a form according to claim 4, wherein the laminate comprises a front, a first and a second web, wherein the first web, as viewed from the front, comprises the flat substrate, the first adhesive layer, the first dividing layer and the first carrier layer, wherein the second web, as viewed from the front, comprises the top layer, the second adhesive layer, the second dividing layer and the second carrier layer, and wherein the first and second webs are connected to each other along a side edge.

11. The laminate according to claim 10, wherein the connection of the first and second webs is achieved by the first dividing layer and the first carrier layer of the first web simultaneously being the second dividing layer and the second carrier layer of the second web.

12. The laminate according to claim 10, wherein the connection of the first and second webs is achieved by the first dividing layer and the first carrier layer of the first web partially overlapping the second web and thereby partially forming the second dividing layer and the second carrier layer of the second web, or by the second dividing layer and the second carrier layer of the second web partially overlapping the first web and thereby partially forming the first dividing layer and the first carrier layer of the first web.

13. The laminate according to claim 11, wherein the top layer and the flat substrate is formed by a continuous printable foil layer and that the continuous printable foil layer has an opaque coating in the region of the flat substrate and/or the first adhesive layer is an opaque adhesive layer.

14. A method for producing a personalised folding card which is plasticised on both sides and comprises two core parts and two covering parts;
wherein, in the finished folding card, the two core parts comprising a substrate and a first adhesive layer are adhesively bonded in a coextensive manner to each other with the first adhesive layer, and at least one of the two outwardly facing surfaces of the substrate is personalised, and wherein the two covering parts comprising a top layer and a second adhesive layer are adhesively bonded in a coextensive manner to the outwardly facing surfaces of the two core parts with the second adhesive layer;
using a form according to claim 1, in which the two core parts and the two covering parts can each be removed and are integrated in a connected manner along a fold line, wherein said method comprises the following steps:
personalizing at least one surface of the substrate of the two core parts in the first page of the form containing the core parts;
removing the two core parts from the first page of the form containing the core parts;
folding up the two core parts along the fold line and adhesively bonding the two core parts to each other by the first adhesive layers;
detaching a first covering part of the two covering parts from the second page of the form containing the covering parts in such a manner that the second covering part connected to the first covering part remains at least partially connected to the page to form a depression;
inserting the core parts which are adhesively bonded to each other into the depression produced by the detachment of the first covering part;
adhesively bonding of the first, detached covering part to the upper core part of the two core parts in the depression;
removing the core parts plasticised by the first covering part on one side in this manner from the depression together with the second covering part from the second page of the form containing the two covering parts; and
adhesively bonding the second covering part to the previously lower core part of the two core parts in the depression by folding together the two covering parts along the fold line.

15. A method for producing a personalised folding card which is plasticised on both sides and comprises two core parts and two covering parts;
wherein, in the finished folding card, the two core parts comprising a substrate and a first adhesive layer are adhesively bonded in a coextensive manner to each other with the first adhesive layer, and at least one of the two outwardly facing surfaces of the substrate is personalised, and wherein the two covering parts comprising a top layer and a second adhesive layer are adhesively bonded in a coextensive manner to the outwardly facing surfaces of the two core parts with the second adhesive layer;
using a form according to claim 2 wherein, in which the two core parts and the two covering parts are each integrated in a removable manner, wherein said method comprises the following steps:
personalizing at least one surface of the substrate of the two core parts in the first page of the form containing the core parts;
removing the two covering parts from the second page of the form containing the covering parts to form a depression;
inserting the two covering parts into the depression produced by the removal of the two covering parts in such a manner that the second adhesive layer is exposed;
folding up of the form along a fold line in the form centrally between the core parts and the covering parts in such a manner that the personalised surface of the two core parts is adhesively bonded in a coextensive manner with the two covering parts, in order to plasticise the two core parts;
folding back of the form along the fold line in such a manner that the two covering parts are removed from the depression;
removing the two core parts plasticised in this manner by the two covering parts from the first page of the form containing the two core parts; and
folding up the two core parts together with the two covering parts along the fold line and adhesively bonding the two core parts to each other by the first adhesive layers.
